(19) United States
(12) Patent Application Publication
(10) Pub. No.: US 2012/0258303 A1
(43) Pub. Date: Oct. 11, 2012

(54) Multi-Layer Sheet Material and Method for the Production thereof

(76) Inventors: Jürgen Bühring, Wedemark (DE); Dirk Iben, Sereetz (DE); Roland Freudenmann, Wedemark (DE); Christian Seidel, Hannover (DE); Dirk Mielke, Hemmingen (DE)

(21) Appl. No.: 13/529,382

(22) Filed: Jun. 21, 2012

Related U.S. Application Data
(63) Continuation of application No. PCT/EP2010/067372, filed on Nov. 12, 2010.

(30) Foreign Application Priority Data
Feb. 1, 2010 (EP) 10152222.5

(51) Int. Cl. B32B 27/06; B32B 38/06; B32B 38/00; B32B 5/18

(52) U.S. Cl. 428/318.6; 156/220; 156/246; 156/244.11

(57) ABSTRACT

A multi-layer sheet material includes at least one textile substrate layer, at least one foamed layer made of polyvinyl chloride containing plasticizer, at least one cover layer made of polyvinyl chloride containing plasticizer, and at least one coating layer facing outward on the cover layer. The invention further relates to a method for producing the multi-layer sheet material and to an interior trim part made of a sheet material for a vehicle. For a reduced tendency to yellow under high-temperature aging and for greater color fastness, the polyvinyl chloride fraction in the cover layer is based at least 50 wt% on a polyvinyl chloride that was produced according to the method of suspension polymerization (S-PVC), and the composition for the cover layer comprises a calcium hydroxide stabilizer and/or a Ca/Zn stabilizer that contains 1 to 3 wt% calcium and 1 to 2 wt% zinc.

### CROSS REFERENCE TO RELATED APPLICATIONS

This application is a continuation application of international patent application PCT/EP 2010/067372, filed Nov. 12, 2010, designating the United States and claiming priority from European application 10152222.5, filed Feb. 1, 2010, and the entire content of both applications is incorporated herein by reference.

### FIELD OF THE INVENTION

The invention relates to a multilayer sheet-like structure, comprising at least one textile backing layer, at least one foamed layer made of plasticized polyvinyl chloride, at least one outer layer made of plasticized polyvinyl chloride, and at least one outward-facing lacquer layer on the outer layer. The invention further relates to a process for producing the multilayer sheet-like structure, and also to an interior cladding component composed of a sheet-like structure, for a vehicle.

### BACKGROUND OF THE INVENTION

Sheet-like structures made of plasticized polyvinyl chloride on a textile backing layer are well-known for the interior cladding of motor vehicles and for furniture, bags, or the like, and by way of example are used in vehicles as covering of seats and of door inserts. Another term commonly used for sheet-like structures of this type is synthetic leather. They are described by way of example in DD 130491 A1. The sheet-like structures usually have a multilayer structure, often have a foam backing, and on their upper side have a three-dimensionally structured, embossed surface, namely what is known as a patterning or grain, in a very wide variety of shapes and types. The multilayer structure is often composed of an upper, optionally lacquered, outer or decorative layer, which is embossed, and optionally of a foamed intermediate layer, and of a textile backing layer which by way of example has been bonded to the other layers by way of a layer of lamination adhesive.

Plasticizers used in the layers made of polyvinyl chloride (PVC) in the synthetic leather are mainly phthalates, such as diisononyl phthalate (DINP) or diisodecyl phthalate (DIDP), sebacates, such as dioctyl sebacate (DOS), trimellitates, such as tri-2-ethylhexyl trimellitate (TOTM), or similar petroleum-based compounds. It is also known by way of example from EP 1 294 799 B1 that fatty acid products based on vegetable oils can be used as plasticizers for PVC.

Various materials can be used for the textile backing layer, and these can take the form of knits, wovens, or nonwovens. The underlying material used is generally polyester, cotton, polyamide, or mixed wovens/formed-loop knits derived therefrom, where polyester and polyamide are chemically produced fibers made of synthetic polymers (synthetic fibers).

The sheet-like structures are generally produced by the coating process, by means of reverse coating or of direct coating. The materials used here are grades of EPVC, which are produced by means of the emulsion polymerization process. When grades of EPVC are mixed with plasticizer they have a paste-like liquid consistency and can therefore be processed by the coating process. Another possible production process provides calendering of individual layers. Here, it is also possible to use grades of what is known as SPVC. SPVC is produced by means of the suspension polymerization process. The solid consistency of SPVC generally prevents its use for a coating process. The SPVC composition is generally plastified only when it is exposed to the elevated temperature in the compounding assemblies which precede a calender, for example a kneader or extruder, and only then can it be molded by means of the calender rolls to give a film. However, there are specific grades of microsuspension PVC which exhibit behavior similar to that of EPVC.

A disadvantage hitherto of sheet-like structures with layers made of plasticized polyvinyl chloride is that the degradation of the PVC molecule causes yellowing on heat-aging at elevated temperatures, in particular above 100° C., and their use by way of example for motor-vehicle instrument panels (dashboards) is possible only if the yellowing is occluded by a dark underlying color of the sheet-like structure, in particular black or dark brown. The surface-temperature of motor-vehicle instrument panels exceeds 100° C. when the vehicle is standing in the sun. Conventional PVC stabilizers have not hitherto been able to mitigate the problem of yellowing in sheet-like structures comprising EPVC. When relatively pale colors are desired for instrument panels with a sewn cover, as is the current trend, current practice is therefore to use real leather or polyurethane-based synthetic leather.

### SUMMARY OF THE INVENTION

The invention is based on the object of providing a multilayer sheet-like structure which has layers made of plasticized polyvinyl chloride in the manner mentioned in the introduction and which has reduced tendency toward yellowing and therefore performs exceptionally well during heat-aging, and therefore has increased resistance to discoloration. The invention achieves the object in that at least 50% by weight of the polyvinyl chloride content in the outer layer is based on a polyvinyl chloride which has been produced by the suspension polymerization process (SPVC), and the composition for the outer layer comprises a calcium hydroxide stabilizer and/or a Ca/Zn stabilizer which comprises from 1 to 3% by weight of calcium and from 1 to 2% by weight of zinc.

Surprisingly, it has been found that improved resistance to discoloration can be achieved, that is, that after aging for 2 weeks at 120° C. a gray-scale classification of GS 4 is obtained even if the color of the sheet-like structure is pale gray or another pale color. If the sheet-like structure is used as outer covering for a motor-vehicle instrument panel, the tendency toward yellowing is found to be markedly reduced. The effect was found only when the calcium hydroxide stabilizer and/or the specific Ca/Zn stabilizer were combined with at least 50% by weight of SPVC in the outer layer, based on the total content of PVC in the outer layer. The effect was not found if the stabilizers were used in EPVC alone.

At least 50% by weight of the PVC content of the composition of the outer layer is based on SPVC, but the remaining PVC content can be EPVC. However, it is preferable that at least 75% by weight, particularly at least 95% by weight, of the PVC content of the outer layer is based on SPVC, with resultant process-technology advantages during the calendering of the outer layer, and resultant advantages in thermal stability.

The composition for the outer layer comprises, as stabilizers, a calcium hydroxide stabilizer and/or a specific Ca/Zn stabilizer. The Ca/Zn stabilizer involves the metal soap stabilizers conventional in PVC processing. The specific content of from 1 to 3% by weight of calcium and from 1 to 2% by weight of zinc in this type of stabilizer is important.

In order to achieve particularly good protection from yellowing, it has proven advantageous for the composition for the outer layer to comprise from 0.5 to 10 phr (parts per hundred parts of resin by weight), preferably from 2 to 6 phr, of the Ca/Zn stabilizer.

As an alternative to this, the composition for the outer layer can also comprise from 1 to 20 phr, preferably from 3 to 10 phr, of a calcium hydroxide stabilizer.

In one preferred development of the invention, the composition for the outer layer comprises a perchlorate as further stabilizer. There is a resultant further improvement in resistance to discoloration, and a resultant improvement in amine resistance. Gray-scale values of ≧4.5 can be achieved in relation to amine resistance.

The use of a sodium perchlorate as perchlorate is particularly effective in relation to amine resistance. However, it is also possible to use other perchlorates.

In one advantageous embodiment of the invention, if the composition for the outer layer comprises the Ca/Zn stabilizer, the ratio by weight of calcium plus zinc from the Ca/Zn stabilizer to perchlorate in the composition for the outer layer is from 1:0.5 to 1:10, preferably from 1:1 to 1:6. At ratios below these ratios, amine resistance becomes poorer, and increased yellowing is found during heat-aging. Excessive amounts of stabilizer increase the cost of the sheet-like structures without additional benefits and sometimes lead to poorer thermal stability.

If the composition for the outer layer comprises calcium hydroxide as stabilizer, the ratio by weight of calcium hydroxide stabilizer, that is, Ca(OH)₂, to perchlorate in the composition for the outer layer is from 20:1 to 1:1, preferably from 8:1 to 14:1.

The composition for the outer layer can also comprise, alongside the stabilizers mentioned, conventional amounts of further PVC stabilizers as known to the person skilled in the art. Among these stabilizers are CH-acid compounds (such as β-diketones, dihydropyridines, acetylacetonates), antioxidants (such as hindered phenols, sterically hindered amines), polyols, hydrotalcites, zeolites, and organic stabilizers.

In order to reduce the extent of condensation of vaporized volatile substances on the inner side of glass panes in the passenger compartment of the motor vehicle, with formation of light-scattering films, known as fogging, it is advantageous for the plasticizers in the PVC layers of the sheet-like structure to be based on phthalate and/or trimellitate, and to have a molar mass M_{W} of at least 470 g/mol. It is thus possible to comply with the VDA 278 emission requirement with a VOC value 100 ppm and a FOG value 250 ppm, and also to comply with DIN 75201 fogging, with a condensate value<1.3 mg, measured over 16 h at 120° C.

The PVC layers present in the sheet-like structures comprise, alongside plasticizer and stabilizers, the conventional additives, for example, agents to inhibit aging (for example, antioxidants), fillers, flame retardants (antimony trioxide), blowing agents (for example, azodicarbonamide), pigments (for example, carbon black, titanium dioxide), and other auxiliary substances (for example, viscosity aids, adhesion promoters, et cetera).

The textile backing layer of the sheet-like structure can be based on natural fibers or on chemically produced fibers, which can also be used as hybrid fibers or mixed wovens, or as mixed knits. By way of example, it is possible to use a drawn-loop knit made of cotton fibers and of polyester fibers, preferably in a mixing ratio of 35:65.

The textile backing layer can take the form of knitted fabric. However, it is also possible to use wovens and nonwovens. It is advantageous that the textile backing layer takes the form of a drawn-loop knit, in order to achieve the property profile desired for application as synthetic leather.

The multilayer sheet-like structure has at least one foamed layer made of plasticized polyvinyl chloride. The film can thus be given a “soft” hand, that is, the customer receives sheet-like structures which are particularly attractive and soft to the touch.

The multilayer sheet-like structure moreover has an outward-facing lacquer layer applied to the outer layer. Lacquers that can be used are those presented by Dr. Iben at the SKZ conference on pastes in Würzburg on Sep. 27, 2001, where the application methods were also described. The multilayer sheet-like structure preferably has a lacquer layer comprising polyurethane and/or comprising polyvinyl chloride/acrylate. The lacquer layer ensures that the abrasion properties are improved and that high resistance to suntan lotion is achieved. The lacquers can moreover provide antisqueak properties. Dispersion-based, that is, water-based, lacquers are particularly advantageous for compliance with the low VDA 278 emission requirements with VOC 100 ppm.

For an ideal product in respect of the desired property profile of the sheet-like structure, in particular of a synthetic leather, it has proven to be advantageous for the multilayer sheet-like structure to have the following structure in the stated sequence:
lacquer layer, comprising polyurethane and/or PVC-acrylate,
outer layer made of plasticized polyvinyl chloride,
optionally, foamed intermediate layer made of plasticized polyvinyl chloride,
layer of lamination adhesive,
textile backing layer.

The individual layers here have different functions. The mostly transparent lacquer layer adjusts the glass level, and also adjusts surface properties, such as abrasion resistance, haptic properties, scratch resistance, heat resistance, light resistance, and solvent resistance with respect to cleaners. The outer layer made of plasticized polyvinyl chloride is utilized for coloring and has a supportive effect in relation to resistance to abrasion, scratching, and cleaning compositions. It should be heat- and light-resistant. The intermediate layer can have a foamed or compact structure. The foam layer serves mainly to achieve leather-like haptic properties. The intermediate layer also serves to avoid impression of the textile structure through the material during reverse lamination of the composite onto a component. The textile backing layer is substantially responsible for the mechanical properties, such as extensibility, tensile strength, and tear-propagation resistance, of the entire sheet-like structure, and has to be selected accordingly.

The multilayer sheet-like structure is preferably a synthetic leather which features high resistance to discoloration during heat-aging.

A particularly suitable process for producing the multilayer sheet-like structure of the invention consists of a combination of reverse coating process and calendering process or extrusion process. The outer layer made of plasticized polyvinyl chloride is first produced here, with the conventional associated additives, by means of a calendering process or of an extrusion process.

After this, or alongside this, the “substructure” of the film, namely one or more layers made of plasticized polyvinyl chloride, is produced with the textile backing layer by the reverse coating process, where the layer(s) made of plasticized polyvinyl chloride is/are successively coated onto a backing material, that is, preferably onto a backing film made of, for example, paper, the textile backing layer is placed onto the final layer, and then the layer composite resulting from the coating process, inclusive of the textile backing layer is dried and is peeled from the backing material. This concludes the reverse coating process for this partial composite.

The outer layer is then joined to further layers. To this end, the outer layer produced by the calendering process or extrusion process is applied by lamination, generally through adhesive bonding by means of adhesive, or what is known as thermal lamination, namely adhesive-bonding under hot conditions, to the layer composite resulting from the reverse coating process and made of further layers and of textile backing layer.

Subsequently or previously, the external surface of the outer layer is lacquered and optionally embossed, and hence the multilayer sheet-like structure of the invention is then complete. The product of the invention can also then be laminated to, or bonded to, further layers, for example, foams and further textiles, where these are necessary for processing purposes or to increase perceived quality. The sequence of the steps can vary, as described above.

The sheet-like structure of the invention can be used particularly advantageously as interior-cladding component for a vehicle, and in particular for a motor-vehicle instrument panel which, even in the case of pale colors, has high resistance to discoloration and low susceptibility to yellowing.

### BRIEF DESCRIPTION OF THE DRAWING

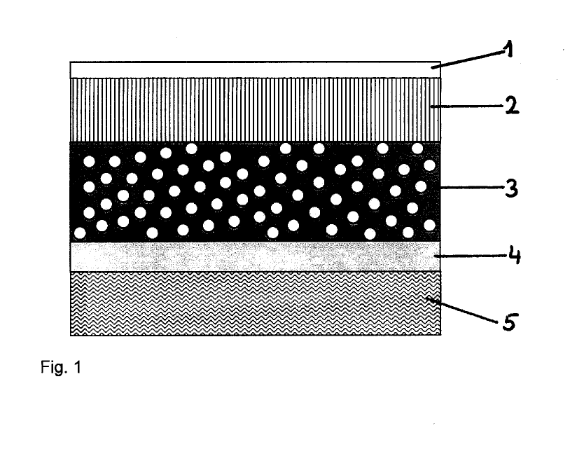

The invention will now be described with reference to the single figure of the drawing (FIG. 1) which shows the structure of a sheet-like structure of the invention in section.

### DESCRIPTION OF THE PREFERRED EMBODIMENTS OF THE INVENTION

FIG. 1 shows the structure of a sheet-like structure of the invention for a motor-vehicle instrument panel in section. Underneath a lacquer layer 1, which is in essence based on polyurethane and/or PVC-acrylate, and the thickness of which is from 2 to 10 μm, the arrangement has an outer layer 2, which comprises SPVC and plasticizer, a Ca/Zn stabilizer, and further additives. This is followed by a conventional intermediate layer 3 made of foamed EPVC with plasticizer, stabilizers, blowing agents, and further additives. A textile backing layer 5 has been applied by lamination from below to the intermediate layer 3 by means of an adhesive 4 made of EPVC with plasticizer, stabilizers, and further additives. The textile backing layer 5 in this exemplary embodiment is composed of a drawn-loop knit made of cotton and polyester.

Table 1 below gives possible ranges of amounts for the mixture composition for the polyvinyl chloride outer layer 2, and also a specific example.

TABLE 1

| | Ranges of amounts | Specific example |
|---|---|---|
| Composition | [parts by wt.] | [parts by wt.] |
| SPVC | 50-100 | 100 |
| EPVC | 0-50 | 0 |
| Plasticizer^{a} | 45-130 | 61 |
| Ca/Zn stabilizer^{b} | 0.5-10 | 4 |
| Perchlorate | 0.2-4 | 0.8 |
| stabilizer | | |
| Lubricant^{c} | 0-1 | 0.2 |
| Pigments | 0-20 | different, |
| | | depending on color |
| Further additives^{d} | 0-100 | ca. 1 |

^{a}based on trimellitate and/or phthalate
^{b}Ca content: about 2.1% by weight, Zn content: about 1.2% by weight
^{c}polyethylene wax and/or acrylate
^{d}flame retardants, fillers, etc.

The compositions given in Table 1 can produce multilayer sheet-like structures which feature low susceptibility to yellowing and high resistance to discoloration even when they are exposed for prolonged periods to temperatures above 100° C. They are therefore suitable, for example, as synthetic leather for motor-vehicle instrument panels.

It is understood that the foregoing description is that of the preferred embodiments of the invention and that various changes and modifications may be made thereto without departing from the spirit and scope of the invention as defined in the appended claims.

### REFERENCE NUMERAL LIST

(part of description)
1 Lacquer layer
2 Outer layer made of polyvinyl chloride
3 Intermediate layer made of foamed polyvinyl chloride
4 Layer of lamination adhesive made of polyvinyl chloride
5 Textile backing layer

What is claimed is:

1. A multilayer sheet-like structure, comprising at least one textile backing layer, at least one foamed layer made of plasticized polyvinyl chloride, at least one outer layer made of plasticized polyvinyl chloride, and at least one outward-facing lacquer layer on the outer layer, wherein at least 50% by weight of the polyvinyl chloride content in the outer layer is based on a polyvinyl chloride which has been produced by the suspension polymerization process (SPVC), and the composition for the outer layer comprises a calcium hydroxide stabilizer and/or a Ca/Zn stabilizer which comprises from 1 to 3% by weight of calcium and from 1 to 2% by weight of zinc.

2. The multilayer sheet-like structure as claimed in claim 1, wherein at least 75% by weight of the polyvinyl chloride content in the outer layer is based on SPVC.

3. The multilayer sheet-like structure as claimed in claim 2, wherein at least 95% by weight of the polyvinyl chloride content in the outer layer is based on SPVC.

4. The multilayer sheet-like structure as claimed in claim 1, wherein the composition for the outer layer comprises from 0.5 to 10 phr (parts per hundred parts of resin by weight) of the Ca/Zn stabilizer.

5. The multilayer sheet-like structure as claimed in claim 1, wherein the composition for the outer layer comprises from 1 to 20 phr (parts per hundred parts of resin by weight) of a calcium hydroxide stabilizer.

6. The multilayer sheet-like structure as claimed in claim wherein the composition for the outer layer comprises a perchlorate as further stabilizer.

7. The multilayer sheet-like structure as claimed in claim 6, wherein the perchlorate is sodium perchlorate.

8. The multilayer sheet-like structure as claimed in claim 6, wherein the ratio by weight of calcium plus zinc from the Ca/Zn stabilizer to perchlorate in the composition for the outer layer is from 1:0.5 to 1:10.

9. The multilayer sheet-like structure as claimed in claim 7, wherein the ratio by weight of calcium hydroxide stabilizer to perchlorate in the composition for the outer layer is from 20:1 to 1:1.

10. The multilayer sheet-like structure as claimed in claim 1, wherein the plasticizers in the PVC layers are based on phthalate and/or on trimellitate, and have a molar mass M_{W} of at least 470 g/mol.

11. The multilayer sheet-like structure as claimed in claim 1, being a synthetic leather.

12. A process for producing a multilayer sheet-like structure as claimed in claim 1, by carrying out the following steps:
producing the outer layer(s) made of plasticized polyvinyl chloride by means of a calendering process or of an extrusion process,
producing further layers made of plasticized polyvinyl chloride with the textile backing layer by the reverse coating process, where
a) the layer(s) made of plasticized polyvinyl chloride is/are successively coated onto a backing material,
b) the textile backing layer is placed onto the final layer, and
c) the layer composite produced by the coating process is dried and peeled from the backing material,
using lamination to apply the outer layer(s) produced in the calendering process or extrusion process to the layer composite made of further layers produced in the reverse coating process, and
lacquering and optional embossing of the external surface of the outer layer(s).

13. An interior cladding component for a vehicle, comprising the multilayer sheet-like structure as claimed in claim 1.

14. The multilayer sheet-like structure as claimed in claim 1, wherein the composition for the outer layer comprises from 2 to 6 phr (parts per hundred parts of resin by weight) of the Ca/Zn stabilizer.

15. The multilayer sheet-like structure as claimed in claim 1, wherein the composition for the outer layer comprises from 3 to 10 phr (parts per hundred parts of resin by weight) of a calcium hydroxide stabilizer.

16. The multilayer sheet-like structure as claimed in claim 6, wherein the ratio by weight of calcium plus zinc from the Ca/Zn stabilizer to perchlorate in the composition for the outer layer is from 1:1 to 1:6.

17. The multilayer sheet-like structure as claimed in claim 7, wherein the ratio by weight of calcium hydroxide stabilizer to perchlorate in the composition for the outer layer is from 8:1 to 14:1.

18. A motor vehicle instrument panel comprising the multilayer sheet-like structure as claimed in claim 1.
